(19) United States
(12) Patent Application Publication
(10) Pub. No.: US 2024/0089095 A1
(43) Pub. Date: Mar. 14, 2024

(54) FILE ENCRYPTING METHOD AND DEVICE

(71) Applicant: FLYTECH TECHNOLOGY CO., LTD., Taipei City (TW)

(72) Inventor: CHUNHAO TSENG, Taipei City (TW)

(21) Appl. No.: 18/078,173

(22) Filed: Dec. 9, 2022

(30) Foreign Application Priority Data
Sep. 8, 2022 (TW) 111134174

(51) Int. Cl. H04L 9/08; H04L 9/06; H04L 9/32

(52) U.S. Cl. CPC H04L 9/0869; H04L 9/0618; H04L 9/3247

(57) ABSTRACT

The present invention relates to a file encrypting method. The method includes steps of providing a generated value block including a plurality of generated values that are randomly generated; implementing a key generating algorithm to generate an encrypting key and a certificate key based on the plurality of generated values; implementing a security encrypting algorithm based on the encrypting key to convert a plaintext included in a target file into a ciphertext and generating a security block including the ciphertext; implementing a certification encrypting algorithm based on the certificate key to generate a digital certificate based on the plaintext; and selectively writing one of the generated value block, the security block and the digital certificate into a first security file.

### CROSS-REFERENCE TO RELATED APPLICATION

This application claims priority benefit to Taiwan Invention Patent Application Serial No. 111134174, filed on Sep. 8, 2022, in Taiwan Intellectual Property Office, the entire disclosures of which are incorporated by reference herein.

### FIELD

The present invention relates to a file encrypting method and device, in particular to a file encrypting method and device that are executable by an ordinary hardware resource which an ordinary user equipment has and a decrypting key thereof is attached in the security file.

### BACKGROUND

As a convention, digital contents written in the commonly seen and used electronic files, such as, docx files, pptx files, xlsx files, pdf files, jpg files, etc. are not used to be encrypted at all in any way. In many cases, any one can view and edit these files as long as a corresponding processing software is correctly used. In some rare occasions, the processing software provides authors with the function of setting a protection password for the file, to prevent unauthorized editing or access by a third party.

However, in terms of the current level of the software engineering art, there are a few special editor softwares circulating on the Internet and unlimitedly providing for any one to access and download. By using these special editor softwares, users become able to open any type of file even if it is encrypted, to view or even edit the contents therein, or to even take editing actions including additions and deletions for the contents therein.

For instance, various available hex editors, such as, Ultraedit, WinHex, HxD, etc. are all configured with user-friendly interfaces designed based on the concept of the user-centered. These interfaces include a hex (hexadecimal) column and a corresponding text column which the both columns are crossly referred and synchronized up with each other. The hex editors is capable of directly reading the raw binary bytes in the file, and analyzing and displaying them in the text column. Thus, these hex editors enable users to read a file that was supposed to be unreadable, unauthorized to read, or protected by a password. Users can view every byte in the file through the text column, and by operating the hex column, they can directly modify any of the bytes at will.

Faced with these threatens brought by such powerful special editor softwares, the electronic files without being encrypted is apparently lack of enough security.

Although there are some electronic file encrypting methods already provided in the prior art of cryptography, in many cases, most users are the ordinary users who do not have any background or knowledge pertaining to information technology or software engineering. These ordinary users do not like or even resist complicated encryption methods and usually are unable to efficiently manage the sensitive security information, such as, passwords, personal identity codes (PIN), security keys, private keys or certificates. Therefore, the conventional technical encryption solutions, such as, the key distribution center (KDC), the public key infrastructure (PKI), etc. are not quite popular among ordinary users as well.

In addition, most user equipment used by ordinary users are the general desktop home computers or notebook computers. These basic hardwares have no sufficient capability to carry out the file encrypting methods that are highly complicated and demand massive computations.

Accordingly, a novel file contents encrypting method and device is needed, so to provide an effective and easy-to-implement secure protection for ordinary electronic files, and the computational load thereof must be affordable for ordinary hardwares which most ordinary users have as well. Further, the method and device are preferable to operate independently without relying on the KDC technology for key management.

Hence, there is a need to solve the above deficiencies/issues.

### SUMMARY

The present invention relates to a file encrypting method and device, in particular to a file encrypting method and device that are executable by any ordinary hardware resource which an ordinary user equipment has and a decrypting key thereof is attached in the security file.

Accordingly, the present invention provides a file encrypting method. The method includes providing a generated value block including a plurality of generated values that are randomly generated; implementing a key generating algorithm to generate an encrypting key and a certificate key based on the plurality of generated values; implementing a security encrypting algorithm based on the encrypting key to convert a plaintext included in a target file into a ciphertext and generating a security block including the ciphertext; implementing a certification encrypting algorithm based on the certificate key to generate a digital certificate based on the plaintext; and selectively writing one of the generated value block, the security block and the digital certificate into a first security file.

Preferably, the file encrypting method further includes a data protection method, the data protection method including one of: reading the target file from a storage media; creating the first security file, a second security file and a third security file on the storage media; generating the plurality of generated values randomly and the generated value block including the plurality of generated values; selecting a plurality of n generated values started from m-th generated values out of from the plurality of generated values in the generated value block, so to generate the encrypting key by implementing an encrypting key generating algorithm based on the plurality of n generated values; and selecting a plurality of q generated values started from p-th generated values out of from the plurality of generated values in the generated value block, so to generate the encrypting key by implementing a certificate key generating algorithm based on the plurality of q generated values.

Preferably, the file encrypting method further includes a security file allocation method that includes one of: selecting one of the generated value block, the security block and the digital certificate to form a first class block; writing into the first security file in a sequence that an index block is priorly arranged at the head and all the blocks included in the first class block are arranged according to a first random sequence; selecting one of the generated value block, the security block and the digital certificate to form a second class block; writing into the second security file in a sequence that all the blocks included in the second class block are arranged according to a second random sequence; selecting one of the generated value block, the security block and the digital certificate to form a third class block and writing all the blocks included in the third class block into the third security file; and wiring at least the values of n, m, p and q and the first random sequence into the index block.

The present invention further provides a file encrypting device. The device includes a plurality of program modules executed by a processor as follows: a random value generator module configured to randomly generate a plurality of generated values and generate a generated value block including the plurality of generated values; a key generator module configured to implement a key generating algorithm to generate an encrypting key and a certificate key based on the plurality of generated values; an encryptor module configured to implement a security encrypting algorithm based on the encrypting key to convert a plaintext included in a target file into a ciphertext and generate a security block including the ciphertext; a digital certificate module configured to implement a certification encrypting algorithm based on the certificate key to generate a digital certificate based on the plaintext; and a writer module configured to selectively write one of the generated value block, the security block and the digital certificate into a first security file.

Preferably, the file encrypting device further includes one of: a reader module configured to read the target file from a storage media; and the key generator module configured to select a plurality of n generated values started from m-th generated values out of from the plurality of generated values in the generated value block, so to generate the encrypting key by implementing an encrypting key generating algorithm based on the plurality of n generated values and select a plurality of q generated values started from p-th generated values out of from the plurality of generated values in the generated value block, so to generate the encrypting key by implementing a certificate key generating algorithm based on the plurality of q generated values.

Preferably, the file encrypting device further includes a file allocator module configured to execute one of steps of: selecting one of the generated value block, the security block and the digital certificate to form a first class block and assigning a first random sequence to all the blocks included in the first class block; selecting one of the generated value block, the security block and the digital certificate to form a second class block and assigning a second random sequence to all the blocks included in the second class block; and selecting one of the generated value block, the security block and the digital certificate to form a third class block.

The above content described in the summary is intended to provide a simplified summary for the presently disclosed invention, so that readers are able to have an initial and basic understanding to the presently disclosed invention. The above content is not aimed to reveal or disclose a comprehensive and detailed description for the present invention, and is never intended to indicate essential elements in various embodiments in the present invention, or define the scope or coverage in the present invention.

### DESCRIPTION OF THE DRAWINGS

A more complete appreciation according to the present invention and many of the attendant advantages thereof are readily obtained as the same become better understood by reference to the following detailed description when considered in connection with the accompanying drawing, wherein:

FIG. 1 is a hardware structural diagram illustrating the file encrypting device according to the present invention;

FIG. 2 is a block diagram illustrating a plurality of processor executable program modules according to the present invention;

FIG. 3 is a operational process flow chart illustrating a plurality of processor executable program modules included in the present invention;

FIG. 4 is a file structure view demonstrating the first embodiment for the security file included in the present invention;

FIG. 5 is a data structure view demonstrating the index block included in the present invention;

FIG. 6 is a file structure view demonstrating the second embodiment for the security file included in the present invention;

FIG. 7 is a file structure view demonstrating the third embodiment for the security file included in the present invention;

8 is a file structure view demonstrating the fourth embodiment the security file included in the present invention;

FIG. 9 is a schematic view illustrating an editor interface when using a HEX editor to open an unencrypted firmware image file;

FIG. 10 is a schematic view illustrating the editor interface when using a HEX editor to open the firmware image file encrypted through the file encrypting method according to the present invention;

FIG. 11 is a flow chart showing the implementation steps for the data protection method included in the present invention;

FIG. 12 is a flow chart showing the implementation steps for the security file allocation method included in the present invention; and

FIG. 13 is a flow chart showing the implementation steps for the file encrypting method included in the present invention.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

is to be noticed that the term “including,” used in the claims, not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

In general, the commonly seen and used formats for electronic files by ordinary users include but are not limited to: docx, pptx, xlsx, vss, pdf, html, jpg, jpeg, bmp, png, gif, tif, tiff, etc, and the digital contents therein are usually not encrypted by any means. In most cases, any one can operate the corresponding processing softwares to view and edit such files. Alternatively, in some rare cases, the processing softwares provide users with a function to set up a protection password for the files to prevent unauthorized editing or reading coming from a third party.

However, in view of the current level of the software engineering art, quite a few special editor softwares are circulating on and available via the Internet. Through these special editor softwares, users can easily open any type of file even if it is encrypted, to view or even edit the digital contents therein, or to even take such actions as addition or deletion for the contents therein. Hence, it is necessary to provide an easy-to-use encryption method for these commonly seen and used electronic files to protect the digital contents therein and enhance the file security. Such a method must be affordable and is capable of being executed by the hardware resources available in ordinary user equipment.

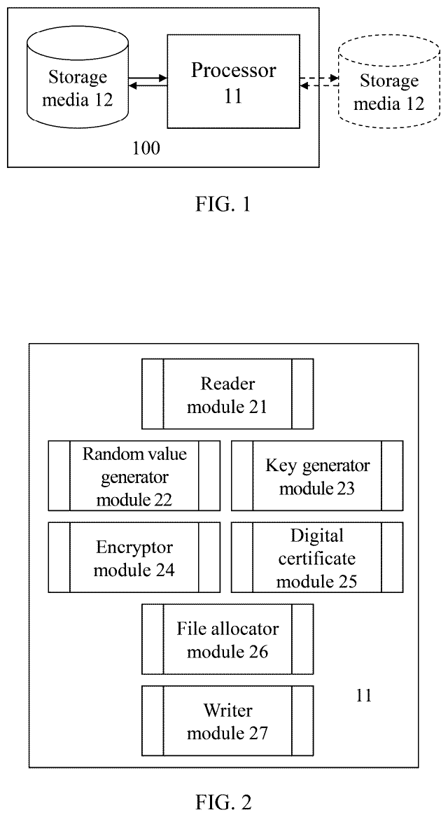

FIG. 1 is a hardware structural diagram illustrating the file encrypting device according to the present invention. The file encrypting device 100 disclosed in the present invention is preferably a user equipment commonly used by the ordinary consumers at present, including but not limited to: a desktop computer, a notebook computer, a smart mobile phone, a tablet device, a mobile device, etc. No matter which type of user equipment is used, the hardware structure for executing the file encryption at least includes a processor 11 and a storage media 12, as shown in FIG. 1. Preferably, the storage media 12 is a built-in storage media installed inside the file encrypting device 100, as well as, it can be an external storage device.

FIG. 2 is a block diagram illustrating a plurality of processor executable program modules according to the present invention. The plurality of program modules used by the present invention to execute the file encryption are pre-stored in the storage media 12, and loaded into the processor 11 to be executed by the processor 11. These program modules include but are not limited to: a reader module 21, a random value generator module 22, a key generator module 23, a encryptor module 24, a digital certificate module 25, a file allocator module 26 and writer module 27.

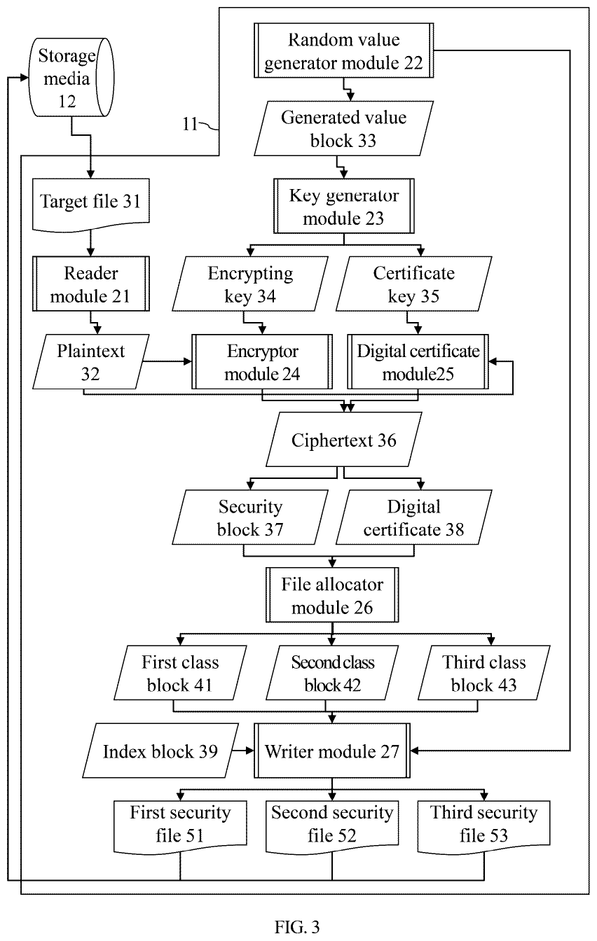

FIG. 3 is a operational process flow chart illustrating a plurality of processor executable program modules included in the present invention. The tasks to be executed by the plurality of program modules are described as below. The reader module 21 reads the target file 31 from the storage media 12. The plaintext 32 included in the target file 31 is the target content intended to be encrypted and protected. Preferably, the original format of the target file 31 includes but is not limited to: docx, pptx, xlsx, vss, pdf, html, jpg, jpeg, bmp, png, gif, tif, tiff, etc.

The random value generator module 22 execute the random value generating algorithm to generate a non-repeating random value with the size of at least 4k bytes, and correspondingly generates a generated value block 33 that contains such generated values. The random value generator module 22 generates the required generated values and the corresponding generated value block instantly whenever there is a need to execute the encrypting operation.

The key generator module 23 picks up a group of n consecutive digits started from the m-th digit out of from the generated values contained in the generated value block 33, and uses them as the seed values to generate the encrypting key. The key generator module 23 then executes an encrypting key generating algorithm based on these seed values to generate an encrypting key 34. Similarly, started from the p-th digit, the key generator module 23 picks up a group of q consecutive digits and uses them as the seed values to generate the certificate key. The key generator module 23 executes the certificate key generating algorithm based on these seed values to generate a certificate key 35. The encrypting key 34 and the certificate key 35 are generated respectively and independently from multiple different segments selected from all random values included in the generated value block 33, to avoid the use of the same segment of random values. Therefore, m is preferably to not be equal to p (m≠p).

The encrypting key generating algorithm and the certificate key generating algorithm can utilize the same or different cryptography methods. Preferably, the encrypting key generating algorithm and the certificate key generating algorithm are selected from one of a RSA algorithm, a DSA algorithm, a MD5 algorithm, a MD4 algorithm, a MD2 algorithm, a SHA-1 algorithm, a SHA-2 algorithm, a SHA-3 algorithm, a RIPEMD-160 algorithm, a MDC-2 algorithm, a GOST R 34.11-94 algorithm, a BLAKE2 algorithm, a Whirlpool algorithm, a SM3 algorithm and a combination thereof.

The encryptor module 24 executes the security encrypting algorithm based on the encrypting key, to encrypt the received plaintext 32, so to convert the plaintext 32 into ciphertext 36 and generate a security block 37 containing the ciphertext 36. The contents of the security block 37 is the data of the target file after encryption. The security encrypting algorithm is preferably selected from one of a AES algorithm, a RSA algorithm, a Blowfish algorithm, a Camellia algorithm, a Chacha20 algorithm, a Poly1305 algorithm, a SEED algorithm, a CAST-128 algorithm, a DES algorithm, a IDEA algorithm, a RC2 algorithm, a RC4 algorithm, a RC5 algorithm, a SM4 algorithm, a TDES algorithm, a GOST 28147-89 algorithm and a combination thereof.

The digital certificate module 25 executes a one-way irreversible certification encrypting algorithm based on the certificate key, to generate a corresponding digital certificate 38 based on the plaintext 32. The certification encrypting algorithm is preferably selected from one of a RSA algorithm, a DSA algorithm, a MD5 algorithm, a MD4 algorithm, a MD2 algorithm, a SHA-1 algorithm, a SHA-2 algorithm, a SHA-3 algorithm, a RIPEMD-160 algorithm, a MDC-2 algorithm, a GOST R 34.11-94 algorithm, a BLAKE2 algorithm, a Whirlpool algorithm, a SM3 algorithm and a combination thereof.

The file allocator module 26 classifies the generated value blocks 33, security blocks 37 and digital certificate 38 into a first class block 41, a second class block 42 and a third class block 43, and assigns a first random sequence and a second random sequence to all the blocks included in the first class block 41 and second class block 42 respectively, according to the settings given by the user.

By following the sequence that the index block 39 is priorly arranged at the head and the blocks included in the first class block 41 is arranged according to the first random sequence, the writer module 27 writes the blocks included in the index block 39 and first class block 41 into the first security file 51 containing the index block 39, in terms of the allocation by the file allocator module 26.

The writer module 27 writes the blocks included in the second class block 42, in which the blocks included are arranged according to the second random sequence, into the second security file 52, in terms of the allocation by the file allocator module 26.

In terms of the allocation by the file allocator module 26, the writer module 27 writes the blocks included in the third class block 43 into the third security file 53. The first security file 51, the second security file 52 and the third security file 53 are all created by the processor 11. The first security file 51, second security file 52 and third security file 53 are independent upon each other, and transmitted and stored separately.

The user can simply verify whether the first security file 51, the second security file 52 and the third security file 53 are falsified or not by recomputing the digital certificate 38 based on the information provided by the index block 39.

As the first security file 51 contains the index block 39, the first security file 51 is preferably regarded as the master file. The second security file 52 and third security file 53 contain no index block 39, and are executed based on a connection call and request from the first security file 51. Therefore, the second security file 52 and third security file 53 are preferably regarded as the data file.

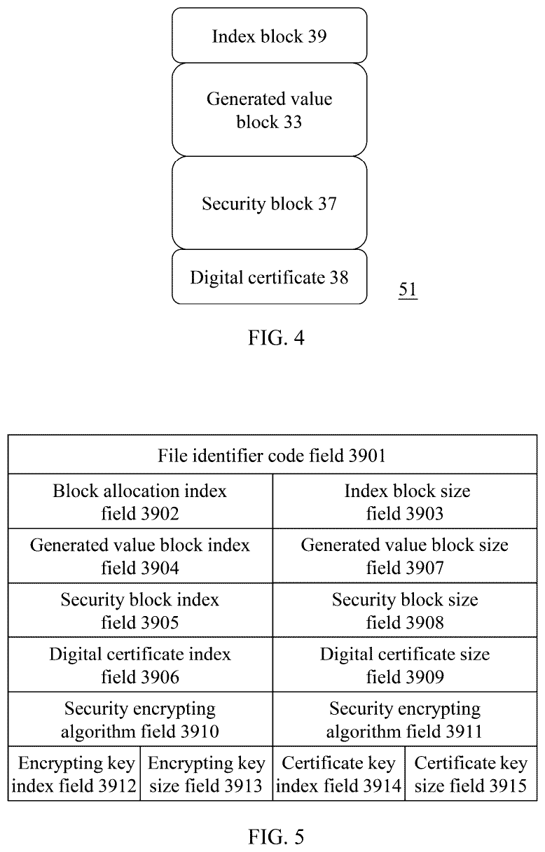

FIG. 4 is a file structure view demonstrating the first embodiment for the security file included in the present invention. As an example, in the present embodiment, the file allocator module 26 groups the three blocks of the generated value block 33, the security block 37 and the digital certificate 38 into the first class block 41 that are ready for writing into the first security file 51 containing the index block 39, and randomly generates a first random sequence to order the sequence of the generated value block 33, the security block 37 and the digital certificate 38 according to the first random sequence. The writer module 27 sequentially writes the index block 39, the generated value block 33, the security block 37, and the digital certificate 38 as well as their contents into the first security file 51 according to the first random sequence, with the prior sequence that the index block 39 is always placed at the head.

FIG. 5 is a data structure view demonstrating the index block included in the present invention. The index block 39 is applied to record the information including at least the size of each block, the block allocation, the encrypting key, the certificate key and the generated values, and is always placed at the head of the file structure for the first security file 51.

For instance, in the first embodiment shown in FIG. 4, the data structure for the index block 39 includes a file identifier code field 3901, a block allocation index field 3902, an index block size field 3903, a generated value block index field 3904, a security block index field 3905, a digital certificate index field 3906, a generated value block size field 3907, a security block size field 3908, a digital certificate size field 3909, a security encrypting algorithm field 3910, a certification encrypting field 3911, an encrypting key index field 3912, an encrypting key size field 3913, a certificate key index field 3914 and a certificate key size field 3915.

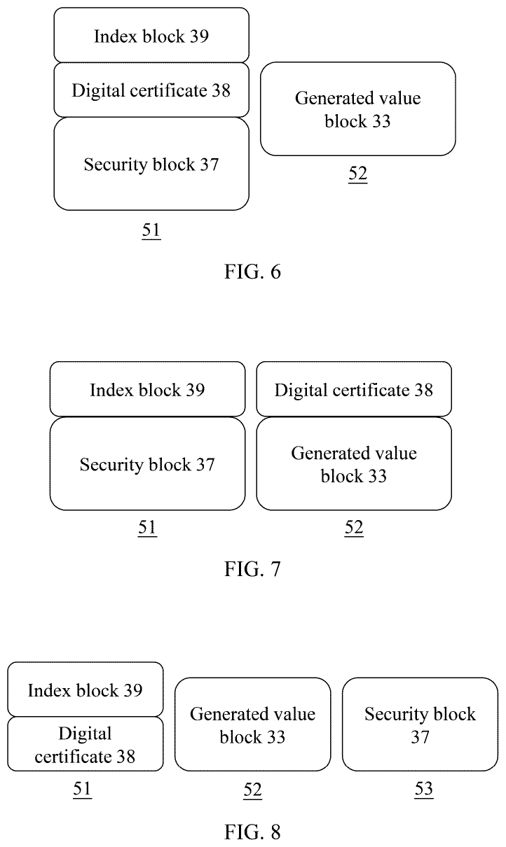

FIG. 6 is a file structure view demonstrating the second embodiment for the security file included in the present invention. In this embodiment, the file allocator module 26 selects two blocks of the security block 37 and digital certificate 38 as the first class block 41 out of from the generated value block 33, the security block 37 and the digital certificate 38, and randomly generates a first random sequence to order the digital certificate 38 and security block 37 accordingly. The file allocator module 26 selects the generated value block 33 as the second class block 42.

The writer module 27 sequentially writes the index block 39, digital certificate 38, security block 37, and their contents into the first security file 51, with the sequence that the index block 39 is priorly placed at the head. The generated value block 33 is separately written into the second security file 52.

FIG. 7 is a file structure view demonstrating the third embodiment for the security file included in the present invention. In this embodiment, the file allocator module 26 selects only the security block 37 as the first class block 41 out of from the generated value block 33, the security block 37 and the digital certificate 38. The generated value block 33 and digital certificate 38 are selected to act as the second class block 42, and a second random sequence is randomly generated to order the sequence of the digital certificate 38 and generated value block 33 accordingly.

The writer module 27 writes the first class block 41 and the contents thereof into the first security file 51, with the index block 39 priorly arranged at the head. Based on the second random sequence, the writer module 27 sequentially writes the digital certificate 38 and generated value block 33 into the second security file 52.

FIG. 8 is a file structure view demonstrating the fourth embodiment for the security file included in the present invention. In this embodiment, the file allocator module 26 selects the digital certificate 38 as the first class block 41, the generated value block 33 as the second class block 42, and the security block 37 as the third class block 43.

The writer module 27 writes the first class block 41 and the contents thereof into the first security file 51 with the index block 39 priorly placed at the head, followed by the digital certificate 38. The writer module 27 writes the second class block 42 that is the generated value block 33 into the second security file 52. The writer module 27 writes the third class block 43 that is the security block 37 into the third security file 53.

In some embodiments, the writer module 27 writes the generated values related information, such as, m and n, into the encrypting key index field 3911 for example, and the generated values related information, such as, p and q, into the certificate key field 3913 for example. Information such as the first class block 41, the second class block 42, the third class block 43, the first random sequence and the second random sequence are written into the block allocation index field 3902.

When a third party intends to view the first security file 51, the second security file 52 or the third security file 53 by operating a special editor software, due to the unawareness of the sequence and the classification for the four blocks and the generating mechanism for the encrypting and certificate keys, even the special editor software fails to analyze and read out the information of the index block 39 contained in the first security file 51 correctly in a correct way. On the other hand, since all the original contents in plaintext included in the target file are encrypted, the third party is yet unable to know the original contents of the target file even by using the special editor software. Thus, the file security is significantly enhanced.

On the contrary, when the user intends to open and execute the first security file 51 by operating the correctly authorized and permitted legit editor software, because the legit editor software embedded with the correct information and cryptography scheme able to correctly utilize the information contained in the index block 39 of the first security file 51, the legit editor software is able automatically call and organize the required second security file 52 or third security file 53, reestablish the encrypting and certificate keys implied inside the file and find out the corresponding decrypting method. Thus, through executing the corresponding reverse decrypting method, the software is able to fully recover the ciphertext 36 contained in the first security file 51, the second security file 52 or the third security file 53 into the original plaintext 32, so to read out the original contents of the target file.

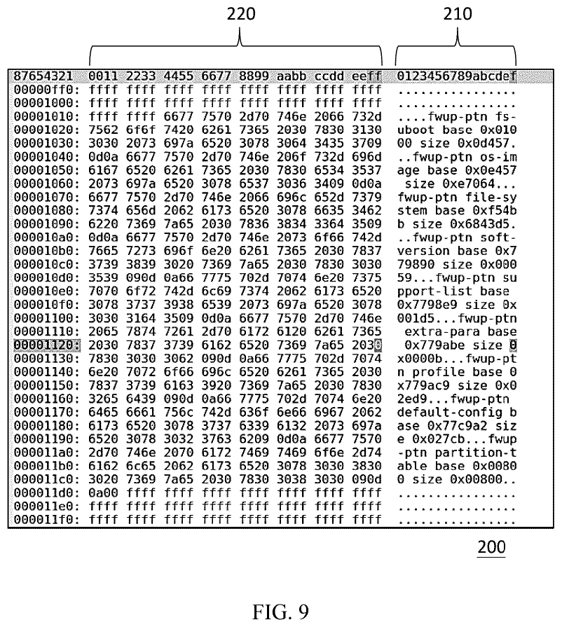

FIG. 9 is a schematic view illustrating an editor interface when using a HEX editor to open an unencrypted firmware image file. When the firmware image file stored in the user equipment is not encrypted in any way, any third party can use any hexadecimal HEX editors to open, view and edit the unprotected firmware image file at will.

As shown in FIG. 9, any third party with unknown attempt can view the firmware image file stored in the user equipment via operating the user interface of a HEX editor, and the critical byte information for the hard disk configuration is directly shown and seen by any third party in the text column 210 of the editor interface 200. The third party can even operate the hex column 220 to arbitrarily modify the firmware image file including the hard disk configuration if so wanted. The unprotected firmware image file is exposed and insecure.

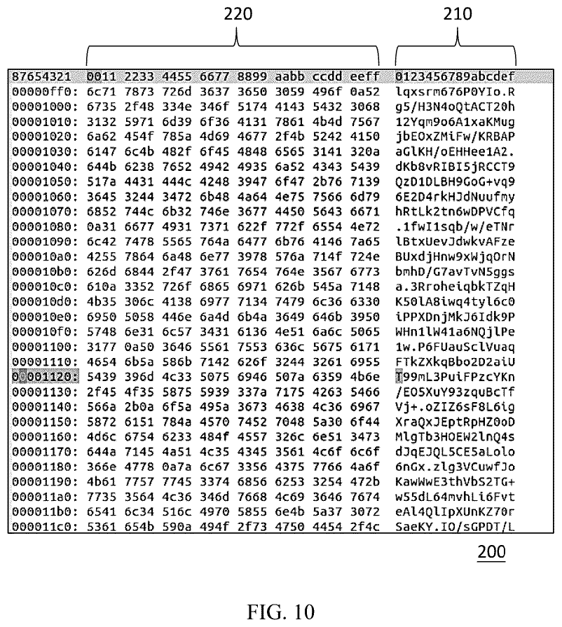

FIG. 10 is a schematic view illustrating the editor interface when using a HEX editor to open the firmware image file encrypted through the file encrypting method according to the present invention. When the firmware image file stored in the user equipment is encrypted by using the file encrypting method according to the present invention, even if any third party opens the encrypted firmware image file by using a HEX editor, the HEX editor fails to read out the original plaintext contents of the file in the text column 210.

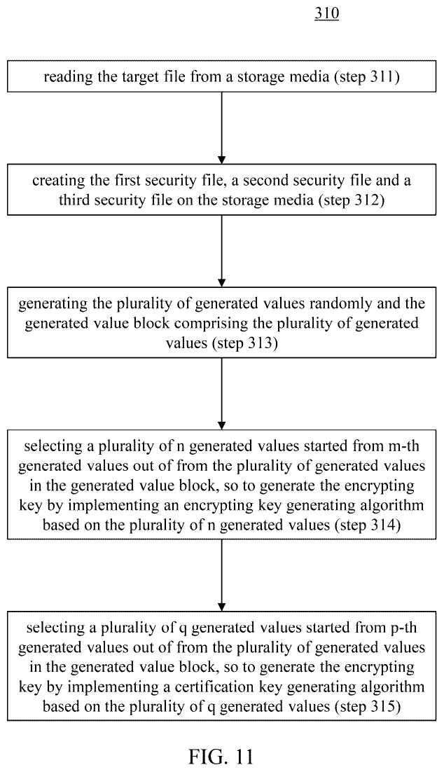

FIG. 11 is a flow chart showing the implementation steps for the data protection method included in the present invention. In summary, the data protection method 310 included in the present invention preferably includes the following steps: reading the target file from a storage media (step 311); creating the first security file, a second security file and a third security file on the storage media (step 312); generating the plurality of generated values randomly and the generated value block comprising the plurality of generated values (step 313); selecting a plurality of n generated values started from m-th generated values out of from the plurality of generated values in the generated value block, so to generate the encrypting key by implementing an encrypting key generating algorithm based on the plurality of n generated values (step 314); and selecting a plurality of q generated values started from p-th generated values out of from the plurality of generated values in the generated value block, so to generate the encrypting key by implementing a certificate key generating algorithm based on the plurality of q generated values (step 315).

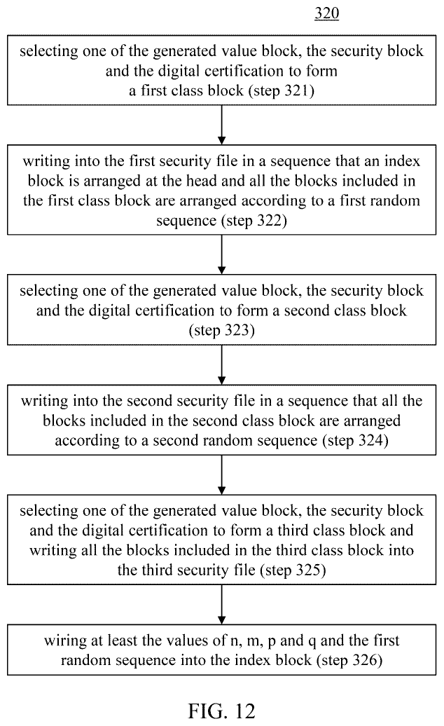

FIG. 12 is a flow chart showing the implementation steps for the security file allocation method included in the present invention. In summary, the security file allocation method 320 included in the present invention preferably includes the following steps: selecting one of the generated value block, the security block and the digital certificate to form a first class block (step 321); writing into the first security file in a sequence that an index block is priorly arranged at the head and all the blocks included in the first class block are arranged according to a first random sequence (step 322); selecting one of the generated value block, the security block and the digital certificate to form a second class block (step 323); writing into the second security file in a sequence that all the blocks included in the second class block are arranged according to a second random sequence (step 324); selecting one of the generated value block, the security block and the digital certificate to form a third class block and writing all the blocks included in the third class block into the third security file (step 325); and wiring at least the values of n, m, p and q and the first random sequence into the index block (step 326).

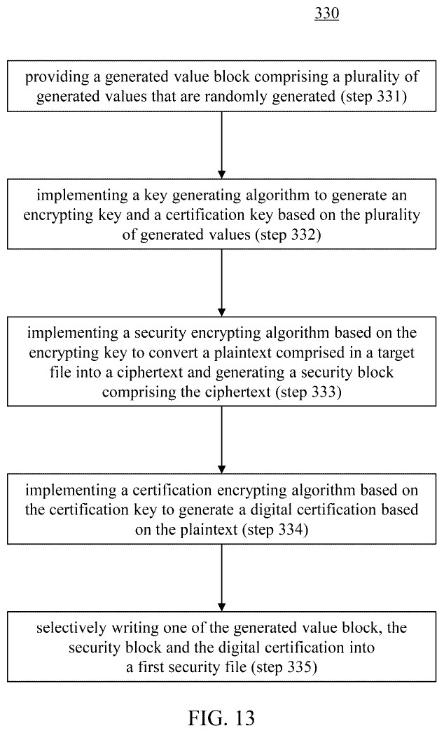

FIG. 13 is a flow chart showing the implementation steps for the file encrypting method included in the present invention. In summary, the file encrypting method 330 included in the present invention preferably includes the following steps: providing a generated value block comprising a plurality of generated values that are randomly generated (step 331); implementing a key generating algorithm to generate an encrypting key and a certificate key based on the plurality of generated values (step 332); implementing a security encrypting algorithm based on the encrypting key to convert a plaintext comprised in a target file into a ciphertext and generating a security block comprising the ciphertext (step 333); implementing a certification encrypting algorithm based on the certificate key to generate a digital certificate based on the plaintext (step 334); and selectively writing one of the generated value block, the security block and the digital certificate into a first security file (step 335).

The file encrypting method disclosed in the present invention hides the digital certificate somewhere inside the file structure. In case when the encrypted contents in the file is edited or falsified unexpectedly, the digital certificate provides a way to authenticate the encrypted contents in time. In addition, as the encrypting key and the certificate key are implied inside the file structure, even if the user forgets the key, the file can still be correctly decoded. The user can frequently change the contents of the key to enhance the file security. The file encrypting method disclosed in the present invention can be quickly executed and implemented using the mediocre hardware resources on the ordinary user equipment, without the use of extra costly equipment. The file encrypting method disclosed in the present invention protects the electronic data recorded in the contents of the file through a low-cost way that is easily implemented by using the existing user equipment.

There are further embodiments provided as follows.

Embodiment 1: A file encrypting method includes: providing a generated value block including a plurality of generated values that are randomly generated; implementing a key generating algorithm to generate an encrypting key and a certificate key based on the plurality of generated values; implementing a security encrypting algorithm based on the encrypting key to convert a plaintext included in a target file into a ciphertext and generating a security block including the ciphertext; implementing a certification encrypting algorithm based on the certificate key to generate a digital certificate based on the plaintext; and selectively writing one of the generated value block, the security block and the digital certificate into a first security file.

Embodiment 2: The file encrypting method as described in Embodiment 1 further includes a data protection method, the data protection method including one of: reading the target file from a storage media; creating the first security file, a second security file and a third security file on the storage media; generating the plurality of generated values randomly and the generated value block including the plurality of generated values; selecting a plurality of n generated values started from m-th generated values out of from the plurality of generated values in the generated value block, so to generate the encrypting key by implementing an encrypting key generating algorithm based on the plurality of n generated values; and selecting a plurality of q generated values started from p-th generated values out of from the plurality of generated values in the generated value block, so to generate the encrypting key by implementing a certificate key generating algorithm based on the plurality of q generated values.

Embodiment 3: The file encrypting method as described in Embodiment 2 further includes a security file allocation method that includes one of: selecting one of the generated value block, the security block and the digital certificate to form a first class block; writing into the first security file in a sequence that an index block is priorly arranged at the head and all the blocks included in the first class block are arranged according to a first random sequence; selecting one of the generated value block, the security block and the digital certificate to form a second class block; writing into the second security file in a sequence that all the blocks included in the second class block are arranged according to a second random sequence; selecting one of the generated value block, the security block and the digital certificate to form a third class block and writing all the blocks included in the third class block into the third security file; and wiring at least the values of n, m, p and q and the first random sequence into the index block.

Embodiment 4: The file encrypting method as described in Embodiment 2, the key generating algorithm, the encrypting key generating algorithm and the certificate key generating algorithm are selected from one of a RSA algorithm, a DSA algorithm, a MD5 algorithm, a MD4 algorithm, a MD2 algorithm, a SHA-1 algorithm, a SHA-2 algorithm, a SHA-3 algorithm, a RIPEMD-160 algorithm, a MDC-2 algorithm, a GOST R 34.11-94 algorithm, a BLAKE2 algorithm, a Whirlpoo algorithm, a SM3 algorithm and a combination thereof.

Embodiment 5: The file encrypting method as described in Embodiment 2, the security encrypting algorithm is selected from one of an AES algorithm, a RSA algorithm, a Blowfish algorithm, a Camellia algorithm, a Chacha20 algorithm, a Poly1305 algorithm, a SEED algorithm, a CAST-128 algorithm, a DES algorithm, an IDEA algorithm, a RC2 algorithm, a RC4 algorithm, a RC5 algorithm, a SM4 algorithm, a TDES algorithm, a GOST 28147-89 algorithm and a combination thereof.

Embodiment 6: The file encrypting method as described in Embodiment 2, the certification encrypting algorithm is selected from one of a RSA algorithm, a DSA algorithm, a MD5 algorithm, a MD4 algorithm, a MD2 algorithm, a SHA-1 algorithm, a SHA-2 algorithm, a SHA-3 algorithm, a RIPEMD-160 algorithm, a MDC-2 algorithm, a GOST R 34.11-94 algorithm, a BLAKE2 algorithm, a Whirlpoo algorithm, a SM3 algorithm and a combination thereof.

Embodiment 7: A file encrypting device includes a plurality of program modules executed by a processor as follows: a random value generator module configured to randomly generate a plurality of generated values and generate a generated value block including the plurality of generated values; a key generator module configured to implement a key generating algorithm to generate an encrypting key and a certificate key based on the plurality of generated values; an encryptor module configured to implement a security encrypting algorithm based on the encrypting key to convert a plaintext included in a target file into a ciphertext and generate a security block including the ciphertext; a digital certificate module configured to implement a certification encrypting algorithm based on the certificate key to generate a digital certificate based on the plaintext; and a writer module configured to selectively write one of the generated value block, the security block and the digital certificate into a first security file.

Embodiment 8: The file encrypting device as described in Embodiment 7 further includes one of: a reader module configured to read the target file from a storage media; and the key generator module configured to select a plurality of n generated values started from m-th generated values out of from the plurality of generated values in the generated value block, so to generate the encrypting key by implementing an encrypting key generating algorithm based on the plurality of n generated values and select a plurality of q generated values started from p-th generated values out of from the plurality of generated values in the generated value block, so to generate the encrypting key by implementing a certificate key generating algorithm based on the plurality of q generated values.

Embodiment 9: The file encrypting device as described in Embodiment 7 further includes a file allocator module configured to execute one of steps of: selecting one of the generated value block, the security block and the digital certificate to form a first class block and assigning a first random sequence to all the blocks included in the first class block; selecting one of the generated value block, the security block and the digital certificate to form a second class block and assigning a second random sequence to all the blocks included in the second class block; and selecting one of the generated value block, the security block and the digital certificate to form a third class block.

Embodiment 10: The file encrypting device as described in Embodiment 7 further includes a writer module configured to execute one of steps of: writing into the first security file in a sequence that an index block is priorly arranged at the head and all the blocks included in the first class block are arranged according to a first random sequence; writing into the second security file in a sequence that all the blocks included in the second class block are arranged according to a second random sequence; and wiring at least the values of n, m, p and q and the first random sequence into the index block.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. A file encrypting method, comprising:
providing a generated value block comprising a plurality of generated values that are randomly generated;
implementing a key generating algorithm to generate an encrypting key and a certificate key based on the plurality of generated values;
implementing a security encrypting algorithm based on the encrypting key to convert a plaintext comprised in a target file into a ciphertext and generating a security block comprising the ciphertext;
implementing a certification encrypting algorithm based on the certificate key to generate a digital certificate based on the plaintext; and
selectively writing one of the generated value block, the security block and the digital certificate into a first security file.

2. The file encrypting method as claimed in claim 1, further comprising a data protection method, the data protection method comprising one of:
reading the target file from a storage media;
creating the first security file, a second security file and a third security file on the storage media;
generating the plurality of generated values randomly and the generated value block comprising the plurality of generated values;
selecting a plurality of n generated values started from m-th generated values out of from the plurality of generated values in the generated value block, so to generate the encrypting key by implementing an encrypting key generating algorithm based on the plurality of n generated values; and
selecting a plurality of q generated values started from p-th generated values out of from the plurality of generated values in the generated value block, so to generate the encrypting key by implementing a certificate key generating algorithm based on the plurality of q generated values.

3. The file encrypting method as claimed in claim 2, further comprising a security file allocation method, the security file allocation method comprising one of:
selecting one of the generated value block, the security block and the digital certificate to form a first class block;
writing into the first security file in a sequence that an index block is priorly arranged at the head and all the blocks comprised in the first class block are arranged according to a first random sequence;
selecting one of the generated value block, the security block and the digital certificate to form a second class block;
writing into the second security file in a sequence that all the blocks comprised in the second class block are arranged according to a second random sequence;
selecting one of the generated value block, the security block and the digital certificate to form a third class block and writing all the blocks comprised in the third class block into the third security file; and
wiring at least the values of n, m, p and q and the first random sequence into the index block.

4. The file encrypting method as claimed in claim 2, wherein the key generating algorithm, the encrypting key generating algorithm and the certificate key generating algorithm are selected from one of a RSA algorithm, a DSA algorithm, a MD5 algorithm, a MD4 algorithm, a MD2 algorithm, a SHA-1 algorithm, a SHA-2 algorithm, a SHA-3 algorithm, a RIPEMD-160 algorithm, a MDC-2 algorithm, a GOST R 34.11-94 algorithm, a BLAKE2 algorithm, a Whirlpool algorithm, a SM3 algorithm and a combination thereof.

5. The file encrypting method as claimed in claim 2, wherein the security encrypting algorithm is selected from one of an AES algorithm, a RSA algorithm, a Blowfish algorithm, a Camellia algorithm, a Chacha20 algorithm, a Poly1305 algorithm, a SEED algorithm, a CAST-128 algorithm, a DES algorithm, an IDEA algorithm, a RC2 algorithm, a RC4 algorithm, a RC5 algorithm, a SM4 algorithm, a TDES algorithm, a GOST 28147-89 algorithm and a combination thereof.

6. The file encrypting method as claimed in claim 2, wherein the certification encrypting algorithm is selected from one of a RSA algorithm, a DSA algorithm, a MD5 algorithm, a MD4 algorithm, a MD2 algorithm, a SHA-1 algorithm, a SHA-2 algorithm, a SHA-3 algorithm, a RIPEMD-160 algorithm, a MDC-2 algorithm, a GOST R 34.11-94 algorithm, a BLAKE2 algorithm, a Whirlpool algorithm, a SM3 algorithm and a combination thereof.

7. A file encrypting device, comprising a plurality of program modules executed by a processor as follows:
a random value generator module configured to randomly generate a plurality of generated values and generate a generated value block comprising the plurality of generated values;
a key generator module configured to implement a key generating algorithm to generate an encrypting key and a certificate key based on the plurality of generated values;
an encryptor module configured to implement a security encrypting algorithm based on the encrypting key to convert a plaintext comprised in a target file into a ciphertext and generate a security block comprising the ciphertext;
a digital certificate module configured to implement a certification encrypting algorithm based on the certificate key to generate a digital certificate based on the plaintext; and
a writer module configured to selectively write one of the generated value block, the security block and the digital certificate into a first security file.

8. The file encrypting device as claimed in claim 7, further comprising one of:
a reader module configured to read the target file from a storage media; and
the key generator module configured to select a plurality of n generated values started from m-th generated values out of from the plurality of generated values in the generated value block, so to generate the encrypting key by implementing an encrypting key generating algorithm based on the plurality of n generated values and select a plurality of q generated values started from p-th generated values out of from the plurality of generated values in the generated value block, so to generate the encrypting key by implementing a certificate key generating algorithm based on the plurality of q generated values.

9. The file encrypting device as claimed in claim 7, further comprising a file allocator module configured to execute one of steps of:
selecting one of the generated value block, the security block and the digital certificate to form a first class block and assigning a first random sequence to all the blocks comprised in the first class block;
selecting one of the generated value block, the security block and the digital certificate to form a second class block and assigning a second random sequence to all the blocks comprised in the second class block; and
selecting one of the generated value block, the security block and the digital certificate to form a third class block.

10. The file encrypting device as claimed in claim 7, further comprising a writer module configured to execute one of steps of:
writing into the first security file in a sequence that an index block is priorly arranged at the head and all the blocks comprised in the first class block are arranged according to a first random sequence;
writing into the second security file in a sequence that all the blocks comprised in the second class block are arranged according to a second random sequence; and
wiring at least the values of n, m, p and q and the first random sequence into the index block.
